(19) United States
(12) Patent Application Publication
(10) Pub. No.: US 2004/0130423 A1
(43) Pub. Date: Jul. 8, 2004

(54) Permanent magnet device

(76) Inventor: Nils Pahlback, Stockholm (SE)

Correspondence Address: JACOBSON HOLMAN PLLC, 400 SEVENTH STREET N.W., SUITE 600, WASHINGTON, DC, 20004, US

(21) Appl. No.: 10/472,754

(22) PCT Filed: Mar. 27, 2002
(86) PCT No.: PCT/SE02/00611

(51) Int. Cl. H01H 9/00

(52) U.S. Cl. 335/306

(57) ABSTRACT

Two cylindrical bodies (1, 2) can be rotated relative to each other about their coaxial axes. One body (1) includes two permanent magnets (21, 22) with their two poles (N, S) exposed to the other body. The pole surface corresponds to a circle sector, wherewith the magnets together fill the circular end surface of said body (1). The other body (2) includes a number of axially through-passing pole shoes corresponding to the number of magnets and the cross-sectional shape of the pole shoes corresponding to the cross-sectional shape of the magnets. Both of said bodies are mounted for rotation relative to each other with the aid of an axial ball bearing (40) at their respective outer circumference.

The present invention relates to a permanent magnet arrangement of the kind defined in the preamble of the accompanying claim 1.

U.S. Pat. No. 3,034,025 discloses a arrangement that corresponds generally to the arrangement defined in the preamble of said claim.

By magnet is meant here a functional unit that includes a functionally interconnected south pole and north pole. The structural design of respective magnets is therefore of subordinate interest. The magnets disposed sequentially around the circumference have the same polarity with respect to their mutually adjacent poles in the circumferential direction. These identical poles may, of course, be separated physically or joined together.

The magnets are carried by a cylindrical plate that is received in a cylindrical bowl which is firmly connected to the pole shoes of the arrangement and which has a radially and outwardly projecting manoeuvring arm that is used to turn the magnets through 90° relative to the pole shoes for adjustment of the arrangement between its off and on modes respectively.

Existing permanent magnets, however, have high magnetic forces relative to their weight and may conveniently be designed to have a large area in the plane normal to their vertical direction and a small thickness in the direction in which they act.

The arrangement known from U.S. Pat. No. 3,034,025, however, cannot be used together with magnets that have high magnetic forces and/or large cross-sectional areas in the direction in which the magnets act, due to the high and troublesome resistance to relative rotation of the bodies.

EP 494028, JP 63312037, U.S. Pat. No. 4,055,824 and U.S. Pat. No. 4,419,644 disclose permanent magnet arrangements that can also be adjusted between their off/on modes, said arrangements including two magnets that can be rotated relative to one another between positions in which the two magnets have different poles in the close proximity of one another and in which said two magnets have similar poles in the close proximity of one another. In the off-mode of the arrangement, the geometry and the magnetic fluxes are such that the bodies obtain an unstable position of rotation relative to one another. Accordingly, one object of the invention is to provide a magnet arrangement with which at least one of the aforesaid problems is avoided either completely or partially.

Another object of the invention is to provide such a arrangement in which the magnetic forces impart stable relative positions of rotation of said two bodies both in the on-mode and in the off-mode of the arrangement when said arrangement co-acts with a ferromagnetic material.

Another object of the invention is to provide a arrangement, which affords stable mounting of the bodies with low friction with respect to their mutual rotation. Accordingly, a particular object of the invention is to provide a simple bearing of small height in the axial direction of the arrangement.

These objects re achieved either completely or partially with a arrangement according to the accompanying claim 1.

Further embodiments of the arrangement will be apparent from the accompanying dependent claims.

In one embodiment of the invention, the two bodies have the form of coaxial cylinders that are mounted for rotation relative to one another around their coaxial axes. The cylinders have generally the same outer diameter. The first body carries two permanent magnets that have a contour corresponding to a semi-circular sector. The two magnets together substantially fill the cross-section of the cylindrical body, with the exception of being separated by a diametrical gap. Each magnet includes two different poles that each have generally the form of a quarter-circle sector and that are located in one end surface of the first body. The different poles are proximal to each other in the circumferential direction of said end surface. The same applies to the other magnet. The second body includes two axially through-passing pole shoes in the shape of two semi-circle sectors. In a first position of rotation, respective pole shoes are in alignment with a magnet, wherewith the poles of the magnet are short circuited by the pole shoe in the end thereof that lies proximal to the first body. As will be understood, the poles of the two magnets are separated by a gap at the surface where they are exposed, and that the magnets are disposed so that said two magnets will have similar poles that are close together in the circumferential direction of the arrangement.

When the two bodies are turned to a second position of rotation relative to each other, one pole shoe will bridge two similar magnet poles, e.g. N-poles, and the other pole shoe will bridge two similar magnet poles (S-poles).

The two bodies attract one another. A rolling bearing is mounted between the bodies at their respective peripheries. The rolling bearing may be a ball bearing. The rolling bearing enables the bodies to turn relative to one another with a small force between the off/on modes of the arrangement even in the case of very strong magnets, and also holds the bodies stable in mutual alignment. As a result of the aforedescribed basic structure of the arrangement (when it co-acts with a ferromagnetic underlying surface), the bodies obtain stable mutual positions of rotation in the on and off modes of the arrangement. Because the first and the second body attract one another, the bearing can be made very simple, by providing the two bodies in the proximity of their respective peripheries and on their two mutually facing main surfaces with co-axial grooves which are bridged by a series of balls between the grooves. The grooves and the balls also function to centre the two bodies.

The person skilled in this art will realise that the magnet arrangement can be modified by providing the arrangement with magnets in an equal number greater than 2 and by giving the magnets essentially the same form and centre angle in said end plane of the first body. The number of pole shoes in the opposing end plane of the second body equals the number of magnets in the end plane of the first body, and each of the pole shoes has a cross-section corresponding to that of respective magnets. The on and off modes of the arrangement will be displaced through 45° when the arrangement comprises 4 magnets, and will be displaced through 22.5° when the arrangement includes 8 magnets, and so on. When a magnet arrangement that includes a larger number of magnets is placed with the free surfaces of the pole shoes against a ferromagnetic undersurface, certain advantages are achieved insofar that the magnetic fluxes in the underlying surface move in the circumferential direction of the arrangement between adjacent pole shoes in said circumferential direction, these advantages being particularly significant when the underlying surface consists of relatively thin plate.

The invention will now be described by way of example with reference to the accompanying drawing.

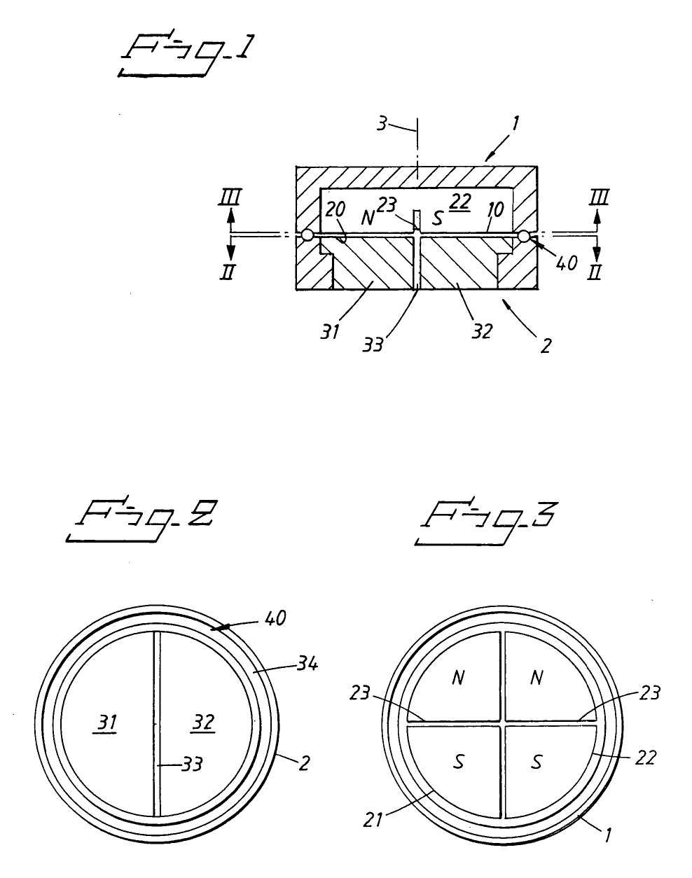

FIG. 1 is an axial sectioned view of an inventive magnet arrangement and shows the arrangement in its off-mode.

FIG. 2 is a view taken on the line II-II in FIG. 1.

FIG. 3 is a view taken on the line III-III in FIG. 1.

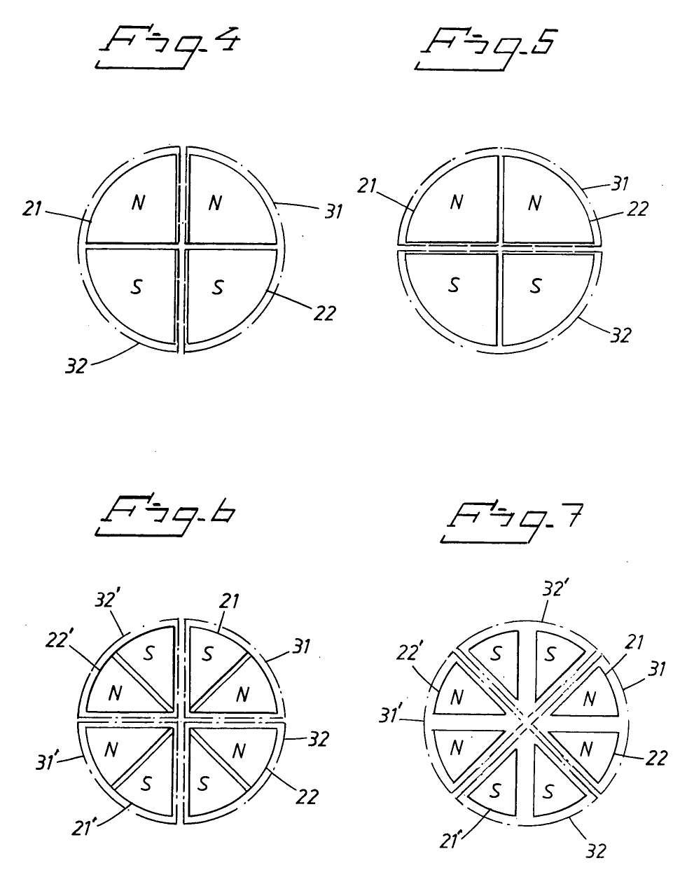

FIGS. 4 and 5 illustrate the relative orientation of the pole shoes and the magnets in the off-mode and in the on-mode of said arrangement respectively.

FIGS. 6 and 7 are views corresponding to the views of FIGS. 2 and 3 and show another embodiment of the arrangement.

FIG. 1 is an axial sectioned view of the magnet arrangement according to the invention. The arrangement includes two cylindrical bodies 1, 2, which can be rotated relative to each other about their rotational symmetry axis 3. The first body 1 includes two permanent magnets 21, 22, which are exposed on one main surface 10 of the body 1. The second body 2 has two axially through-passing pole shoes 31, 32, which are mutually separated by a narrow gap 33 in the axial plane and which have a cross-section generally in the form of a semi-circle sector. It will be apparent from FIG. 3 that the magnets 21, 22 have essentially the same cross-section, size, and shape as the pole shoes 31, 32. The magnets 21, 22 include in the surface 10 of the body 1 a groove 23 which delimits north and south poles N, S, and has generally the form of a quarter-circle sector at the pole surfaces. (See Swedish Text on Page 4 Line 32)

The body 2 and the body 1 are mutually mounted in the proximity of their circumferences and their adjacent surfaces with the aid of rolling bearings 40, such as ball bearings. An attraction force exists between the bodies 1, 2, and hence the balls of the bearing can run in a respective groove in the mutually facing surfaces 10, 20 of the bodies 1, 2.

The bodies 1, 2 and the bearing 40 hold the magnet surfaces and the surfaces of the pole shoes 31, 32 slightly apart.

FIG. 3 shows that the similar poles of the magnets 21, 22 lie adjacent one another in the circumferential direction.

FIG. 4 illustrates schematically the relative orientation of the magnets 21, 22 and the pole shoes 31, 32 in the off-mode of the arrangement. FIG. 5 shows the bodies 1, 2 rotated through 90° relative to the state shown in FIG. 4, and illustrates the on-mode of the arrangement. Thus, FIG. 4 shows that both poles of the magnet 21 are short-circuited by the pole shoe 31, and that the poles of the other magnet 22 are short-circuited by the pole shoe 32. The north poles of the magnets in FIG. 5 are flux-connected to one pole shoe 31, while the other poles are flux-connected to the other pole shoe 32, such as to establish a strong magnetic flux across the gap 33 at the exposed surface 28 of the body 2.

The arrangement includes an even number of magnets that are similarly disposed around the circumference of the body 1 and have generally the shape of circle sectors with the apex at the axis 3. The north and south pole of each magnet are preferably separated at the surface 10 by a gap positioned such that the north and south pole will have generally the same size and contour. Correspondingly, the number of pole shoes is the same as the number of magnets and said shoes also have the cross-sectional shape of circle sectors of the same width as the magnet pole surfaces, such that the pole shoes will bridge adjacent similar magnet poles in one position of rotation and each bridge different poles in respective magnets in another position of rotation.

The apex regions of the sector-shaped exposed surfaces of the magnet poles are utilised less effectively and consequently the centre region of the two bodies 1, 2 can be conveniently kept free from magnetic material. Instead, the body 1 may be provided with an axial central through-passing hole for accommodating a rod whose one end is fastened centrally in the other body 2 for transferring load to and from the arrangement. The body 1 is rotatable relative to the rod.

As mentioned in the introduction, the individual magnets may have any selected structural design. For example, the first body 1 may, in principle, consist of a solid ring that has circumferentially separated regions of alternating polarity, and two (or a multiple of two) poles separated circumferentially. Each pole can then be considered to consist of two circumferentially adjacent pole-parts that each belong to a respective one of two functional magnets disposed sequentially around the circumference.

1. A magnet arrangement comprising at least two bodies (1, 2) that are rotatable relative to each other about an axis (3) and have adjacent surfaces (10, 20) which lie in a plane normal to the axis (3), wherein one body, the first body (1), includes two permanent magnets (21, 22) which expose both of their poles (N, S) in said surface (10) of the first body (1), wherein the exposed mutually adjacent different poles (1, 6) of respective magnets are separated circumferentially in said surface (10), wherein the pole areas each occupy generally the same centre angle in said surface, wherein the second body (2) includes a number of axially through-passing pole shoes (31, 32) which correspond in number to the number of magnets and each of which has in the end plane of the second body adjacent said first body (1) a shape and size corresponding to the area of two circumferentially adjacent magnet poles in said end plane of the first body (1), characterised by a rolling bearing (10) arranged coaxially with the axis (3) between said bodies (1, 2) in the proximity of their circumferences.

2. A arrangement according to claim 1, characterised in that the rolling bearing (4) is a ball bearing.

3. A arrangement according to claim 2, characterised in that the ball bearing includes running tracks that are formed by opposing ring-shaped recesses in respective bodies (1, 2), said ring-shaped recesses accommodating a series of balls therebetween.

4. A arrangement according to any one of claims 1-3, characterised in that the arrangement includes two magnets whose exposed pole surfaces each have generally the form of a circle-sector surface with the top angle 90°./?/

5. A arrangement according to any one of claims 1-3, characterised in that the first body includes an integer multiple of said two magnets, wherein the exposed pole surfaces of respective magnets generally occupy a circle sector, wherein the sectors of said magnets have respective centre angles of mutually the same size and together generally fill-out the end surface (10) of said first body.

6. A arrangement according to claim 5, characterised in that the first body includes at least four magnets.

7. A arrangement according to claim 5, characterised in that the first body includes at least six magnets.
